(19) United States
(12) Patent Application Publication
(10) Pub. No.: US 2017/0028822 A1
(43) Pub. Date: Feb. 2, 2017

(54) CONTROL CIRCUIT FOR FULLY AUTOMATIC AUTOMOBILE SUNSHADE

(71) Applicant: Qiming DU, Zhongshan City, Guangdong Province (CN)

(72) Inventor: Qiming DU, Zhongshan City, Guangdong Province (CN)

(21) Appl. No.: 15/304,419

(22) PCT Filed: Aug. 3, 2015
(86) PCT No.: PCT/CN2015/000550

§ 371 Date: Oct. 14, 2016

(30) Foreign Application Priority Data
Mar. 13, 2015 (CN) 201510110644.0

(51) Int. Cl. B60J 3/02; H02P 6/04; H02K 11/33; H02K 3/18; H02K 1/27; H02K 11/38; B60R 16/023; H02K 1/14

(52) U.S. Cl. CPC B60J 3/02; B60R 16/023; H02P 6/04; H02K 1/14; H02K 3/18; H02K 1/2786; H02K 11/38; H02K 11/33

(57) ABSTRACT

The invention provides a control circuit for a full-automatic automobile sunshade. The control circuit comprises a command receiving circuit used for receiving an external control signal, processing the signal and feeding back the signal to a micro processor. The control circuit also comprises a power supply circuit, a voltage detecting circuit, an unfolding limiting switch, a tightening limiting switch, a first motor, a second motor, a first motor driving circuit and a second motor driving circuit. The control circuit for a full-automatic automobile sunshade has a compact structure; by arranging the micro processor and other circuit components, the unfolding and tightening of the sunshade can be automatically achieved; the labor intensity is greatly lowered; meanwhile, it is convenient to use, and the circuit system is reliable and durable.

### TECHNICAL FIELD

The invention relates to a control circuit, and particularly to a control circuit for full-automatic automobile sunshade.

### BACKGROUND ART

A sunshade is conventionally arranged on a car manually. Four actions required during use are as follows: 1. fixing the sunshade at a proper position on the car; 2. unfolding the sunshade to cover the car body; 3. tightening the sunshade to its original shape; 4. loosening the sunshade fixing means. Such a series of actions are completed manually, causing the sunshade difficult and extremely inconvenient to use. Therefore, an automatic coverable sunshade is urgently needed to be designed.

### SUMMARY OF THE INVENTION

The invention aims to solve the technical problems mentioned in the background art and provides a control circuit for a full-automatic automobile sunshade.

The technical solution of the invention is as follows:

a control circuit for a full-automatic automobile sunshade, comprising a command receiving circuit used for receiving an external control signal, processing the signal and feeding back the signal to a micro processor,

a power supply circuit used for supplying power to the command receiving circuit and the micro processor,

a voltage detecting circuit used for sampling battery voltage, filtering the battery voltage and sending the battery voltage to the micro processor,

an unfolding limiting switch triggered when the sunshade is unfolded to an extreme position and used for sending a signal to the micro processor,

a tightening limiting switch triggered when the sunshade is tightened to an extreme position and used for sending a signal to the micro processor,

a first motor used for driving the sunshade to unfold or tighten,

a second motor used for vacuumizing the air from a sunshade suction disc,

a first motor driving circuit used for receiving a signal sent by the micro processor and controlling the first motor to rotate positively, rotate reversely or stop,

and a second motor driving circuit used for receiving a signal sent by the micro processor and controlling the second motor to start or stop.

As a preferable solution, the command receiving circuit comprises a decoding chip; a pin of the decoding chip is externally connected to an antenna; four pins of the decoding chip are communicated with the micro processor.

As a preferable solution, the power supply circuit comprises a current limiting resistor; the current limiting resistor is electrically connected to two filter capacitors and a voltage stabilizing diode; the two filter capacitors are connected with each other in parallel.

As a preferable solution, the voltage detecting circuit comprises two voltage divider resistors and a capacitor; the two voltage divider resistors are used for sampling battery divided voltage; the capacitor is used for filtering the sampled voltage and feeding the voltage into the micro processor.

As a preferable solution, the first motor driving circuit comprises a micro chip; two pins of the micro chip are respectively communicated with two pins of the micro processor; the micro chip is used for outputting a signal and controlling the first motor to rotate positively, rotate reversely or stop.

As a preferable solution, the second motor driving circuit comprises an MOSFET; one pin of the micro processor is used for controlling connection and disconnection of the MOSFET; the MOSFET is also electrically connected to the second motor.

In conclusion, the control circuit for a full-automatic automobile sunshade of the invention has the following advantages:

the structure is compact; by arranging the micro processor and other circuit components, the unfolding and tightening of the sunshade can be automatically achieved; the labor intensity is greatly lowered; meanwhile, the it is convenient to use, and the circuit system is reliable and durable.

### BRIEF DESCRIPTION OF THE DRAWINGS

FIG. 1 is a block diagram of the circuit according to an embodiment of the invention;

FIG. 2 is a schematic diagram of the circuit according to an embodiment of the invention.

### DETAILED DESCRIPTION OF THE INVENTION

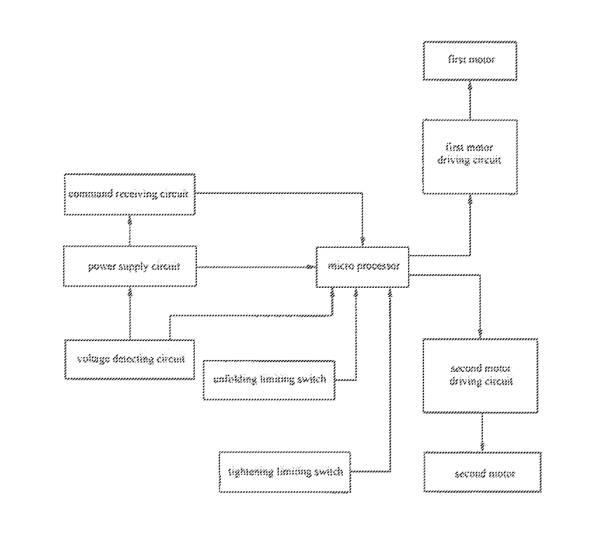

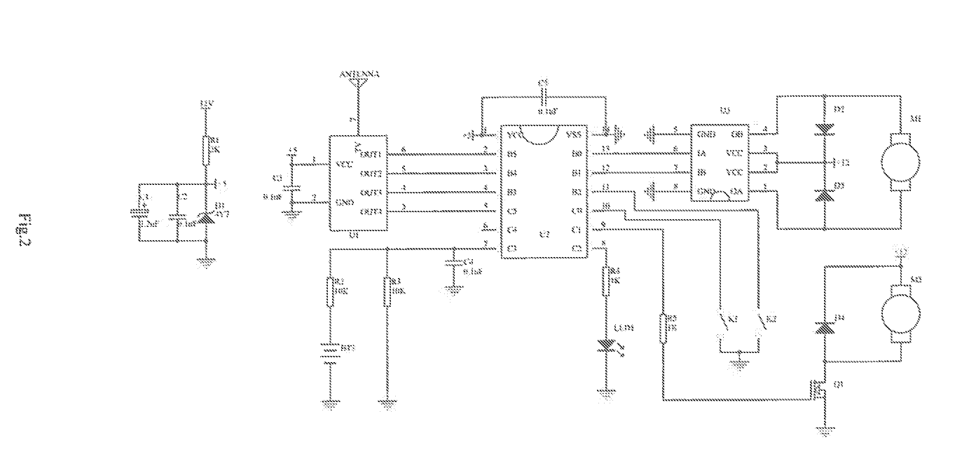

As shown in FIG. 1 and FIG. 2, a control circuit for a full-automatic automobile sunshade comprises a command receiving circuit used for receiving an external control signal, processing the signal and feeding back the signal to a micro processor,

a power supply circuit used for supplying power to the command receiving circuit and the micro processor,

a voltage detecting circuit used for sampling battery voltage, filtering the battery voltage and sending the battery voltage to the micro processor,

an unfolding limiting switch triggered when the sunshade is unfolded to an extreme position and used for sending a signal to the micro processor,

an tightening limiting switch triggered when the sunshade is tightened to an extreme position and used for sending a signal to the micro processor,

a first motor used for driving the sunshade to unfold or tighten,

a second motor used for vacuumizing the air from a sunshade suction disc,

a first motor driving circuit used for receiving a signal sent by the micro processor and controlling the first motor to rotate positively, rotate reversely or stop,

and a second motor driving circuit used for receiving a signal sent by the micro processor and controlling the second motor to start or stop.

The command receiving circuit comprises a decoding chip; a pin of the decoding chip is externally connected to an antenna; four pins of the decoding chip are communicated with the micro processor.

The power supply circuit comprises a current limiting resistor; the current limiting resistor is electrically connected to two filter capacitors and a voltage stabilizing diode; the two filter capacitors are connected with each other in parallel.

The voltage detecting circuit comprises two voltage divider resistors and a capacitor; the two voltage divider resistors are used for sampling battery divided voltage; the capacitor is used for filtering the sampled voltage and feeding the voltage into the micro processor.

The first motor driving circuit comprises a micro chip; two pins of the micro chip are respectively communicated with two pins of the micro processor; the micro chip is used for outputting a signal and controlling the first motor to rotate positively, rotate reversely or stop.

The second motor driving circuit comprises an MOSFET; one pin of the micro processor is used for controlling connection and disconnection of the MOSFET; the MOSFET is also electrically connected to the second motor.

As shown in FIG. 2, R1, is a current limiting resistor, D1 is a 4.7V voltage stabilizing diode, C1 and C2 are 4.7V filter capacitors. R1, D1, C1 and C2 form a +5V power supply system for supplying power to control systems U1 and U2. C3 is a filter capacitor; U1 is a decoding module built by a chip PT2272, which receives a command from a remote controller through an externally connected antenna of a pin \textcircled{7} and decodes the command, and the information after decoding is transmitted to pins \textcircled{2}, \textcircled{3}, \textcircled{4}, \textcircled{5} of a CPU (U2) through pins \textcircled{3}, \textcircled{4}, \textcircled{5}, \textcircled{6} of U1. R2, R3, C4, BT1 form a battery voltage detecting circuit, wherein R2, R3 are used for sampling battery divided voltage, and C4 is used for filtering the sampled voltage and the sampled voltage is fed into a pin \textcircled{7} of the micro processor (U2). K1 and K2 are limiting switches used for controlling the unfolding and tightening extent of the sunshade. When the sunshade is unfolded completely, K1 is closed, and when the sunshade is tightened completely, K2 is closed. A signal of the closure is inputted to pins \textcircled{10}, \textcircled{11} of U2. U2 is a singlechip PICI6F505, and used for calculating and processing the received command information, battery voltage detecting information, unfolding limiting information, tightening limiting information, and the results are outputted to a motor driver Q1, U3 through pins \textcircled{9}, \textcircled{12}, \textcircled{13} U2. U3 is a chip LG9110, which is used for controlling the operation of a motor M1 (i.e. rotating positively, rotating reversely, and stop) according to the command of the micro processor (U2). Q1 is a MOSFET, and the pin \textcircled{9} of the micro processor (U2) is used for controlling connection and disconnection of Q1; when Q1 is disconnected, the second motor M2 stops running. D2, D3 and D4 are diodes In4007, which are used for feeding back transient peak voltage generated when the motors M1 and M2 stop running to a power supply positive electrode VCC.

When the sunshade is in use, it is arranged on the car roof; an ON key of a remote controller is pressed, then the command receiving circuit U1 decodes the received signal and transmitting decoding information to the micro processor U2; the micro processor U2 automatically detects the power supply system after receiving a startup signal; if the power supply system is abnormal, LED1 flashes and alarms, and the startup command is invalid; if the power supply system is normal, the micro processor U2 starts the second motor M2, and the sunshade is fixed on the car roof by means of a suction disc. After the second motor delays running for 5 seconds, the suction force of the suction disc is increased. The micro processor U2 sends a positive rotation command and starting the first motor M1; the sunshade is drawn by the first motor M1 to be slowly unfolded; when the micro processor U2 receives the information that the sunshade is thoroughly unfolded, the first motor M1 stops running, and the step of covering the car body by the sunshade is completed.

When an OFF key of the remote controller is pressed, the command receiving circuit U1 is decodes the received signal and transmits the decoding information to the micro processor U2; the micro processor U2 starts the first motor M1 to rotate reversely after receiving a tightening command; the sunshade is drawn by the first motor M1 to be slowly folded and reset. When the micro processor U2 receives the information that the sunshade is thoroughly folded and reset, the second motor stops running, the suction force of the suction disc is eliminated, and the step of folding the sunshade is completed.

The above description is merely used as explanation of the invention, so that those of ordinary skill in the art can completely implement the solution; however, the above description is not used as limit of the invention. Those of ordinary skill in the art can make modifications without creative contributions on the embodiment according to the requirements after reading the Description. All the modifications without creative contributions in the scope of the claims are protected by the Patent Law.

1. A control circuit for a full-automatic automobile sunshade, characterized by comprising a command receiving circuit used for receiving an external control signal, processing the signal and feeding back the signal to a micro processor,
a power supply circuit used for supplying power to the command receiving circuit and the micro processor,
a voltage detecting circuit used for sampling battery voltage, filtering the battery voltage and sending the battery voltage to the micro processor,
an unfolding limiting switch triggered when the sunshade is unfolded to an extreme position and used for sending a signal to the micro processor,
a tightening limiting switch triggered when the sunshade is tightened to an extreme position and used for sending a signal to the micro processor,
a first motor used for driving the sunshade to unfold or tighten,
a second motor used for vacuumizing the air from a sunshade suction disc,
a first motor driving circuit used for receiving a signal sent by the micro processor and controlling the first motor to rotate positively, rotate reversely or stop,
and a second motor driving circuit used for receiving a signal sent by the micro processor and controlling the second motor to start or stop.

2. The control circuit for a full-automatic automobile sunshade according to claim 1, characterized in that, the command receiving circuit comprises a decoding chip; a pin of the decoding chip is externally connected to an antenna; four pins of the decoding chip are communicated with the micro processor.

3. The control circuit for a full-automatic automobile sunshade according to claim 1, characterized in that, the power supply circuit comprises a current limiting resistor; the current limiting resistor is electrically connected to two filter capacitors and a voltage stabilizing diode; the two filter capacitors are connected with each other in parallel.

4. The control circuit for a full-automatic automobile sunshade according to claim 1, characterized in that, the voltage detecting circuit comprises two voltage divider resistors and a capacitor; the two voltage divider resistors are used for sampling battery divided voltage; the capacitor is used for filtering the sampled voltage and feeding the voltage into the micro processor.

5. The control circuit for a full-automatic automobile sunshade according to claim 1, characterized in that, the first motor driving circuit comprises a micro chip; two pins of the micro chip are respectively communicated with two pins of the micro processor; the micro chip is used for outputting a signal and controlling the first motor to rotate positively, rotate reversely or stop.

6. The control circuit for a full-automatic automobile sunshade according to claim 1, characterized in that, the second motor driving circuit comprises an MOSFET; one pin of the micro processor is used for controlling connection and disconnection of the MOSFET; the MOSFET is also electrically connected to the second motor.
